(19) United States
(12) Patent Application Publication
(10) Pub. No.: US 2017/0095109 A1
(43) Pub. Date: Apr. 6, 2017

(54) BEVERAGE BREWER WITH CONTROL LOGIC RESPONSIVE TO POSITIONING OF BREW BASKET

(71) Applicant: Grindmaster Corporation, Louisville, KY (US)

(72) Inventors: Robert M. Ench, Louisville, KY (US); Thomas Joseph Pfeifer, Louisville, KY (US); John T. Quesenberry, JR., Crestwood, KY (US)

(21) Appl. No.: 15/282,173

(22) Filed: Sep. 30, 2016

Related U.S. Application Data
(60) Provisional application No. 62/237,254, filed on Oct. 5, 2015.

(51) Int. Cl. A47J 31/44

(52) U.S. Cl. CPC A47J 31/446

(57) ABSTRACT

A beverage brewer comprises a housing, with a spray head mounted to the housing and operably connected to a source of water. A brew basket is selectively installed and secured to the housing, with the brew basket holding a quantity of a beverage component below the spray head, such that water introduced by the spray head contacts and passes through the beverage component to produce a brewed beverage. One or more magnets are installed on the brew basket, and one or more magnetic proximity sensors are installed in the housing and positioned to sense the presence of the one or more magnets installed on the brew basket. A control logic then receives signals from the one or more magnetic proximity sensors and executes a selected brewing routine in response to the signals received from the one or more magnetic proximity sensors.

### CROSS-REFERENCE TO RELATED APPLICATIONS

The present application claims priority to U.S. Patent Application Ser. No. 62/237,254 filed on Oct. 5, 2015, the entire disclosure of which is incorporated herein by reference.

### BACKGROUND OF THE INVENTION

The present invention relates to a brewer for brewing a beverage, such as tea or coffee, and, more particularly, to a beverage brewer with a control logic that is responsive to the installation and positioning of the brew basket.

In a common brewer, a brew basket holds a quantity of tea, ground coffee, or similar beverage component below a spray head. The brewer includes a plumbing system in which water is drawn from a water reservoir (or from another water source). As water is drawn from the reservoir and into a hot water tank, hot water is forced from the hot water tank to a spray head. The spray head distributes the hot water over and through the quantity of tea, ground coffee, or similar beverage component, and the brewed beverage is dispensed through an outlet orifice (or drain hole) into a cup or similar receptacle.

Since different beverages may be brewed with the same brewer, it would be advantageous for a desired brewing routine to be selected quickly and with limited user input, for instance, by incorporating a control logic into the brewer that is responsive to the installation and positioning of the brew basket.

### SUMMARY OF THE INVENTION

The present invention is a beverage brewer with a control logic that is responsive to the installation and positioning of the brew basket.

An exemplary brewer made in accordance with the present invention includes a housing, along with a brew basket that is selectively installed and secured to the housing and holds a quantity of tea, ground coffee, or similar beverage component below a spray head installed in the housing. As with prior art brewer constructions, the brewer also includes a plumbing system in which water is drawn from a water reservoir (or from another source of water). As water is drawn from the reservoir and into a hot water tank, hot water is forced from the hot water tank to the spray head. The spray head distributes the hot water over and through the quantity of tea, ground coffee, or similar beverage component held in the brew basket, and the brewed beverage is dispensed through an outlet orifice (or drain hole) into a cup or similar receptacle.

In one exemplary embodiment, the brew basket has a generally cylindrical body defining an internal cavity and an open top, which is circumscribed by an upper flange. One or more magnets are installed on the upper flange of the brew basket, such that the one or more magnets will be positioned near the housing of the brewer when the brew basket is installed.

One or more magnetic proximity sensors are then installed within the housing of the brewer near the spray head, such that the magnetic proximity sensors are positioned to sense the presence of one or more of the magnets installed on the upper flange of the brew basket, i.e., to sense the presence and/or orientation of the brew basket. A control logic receives signals from each of the magnetic proximity sensors. Based on such signals, the control logic can confirm the presence and/or orientation of the brew basket, and thus can determine, for example, whether tea or coffee is to be brewed, or whether a particular brewing routine is desired. When a brewing cycle is then initiated by a start button or similar user input, the control logic retrieves a brewing routine, which is a set of computer-readable instructions, from a memory component. The control logic executes those instructions and communicates appropriate control signals to the plumbing system based, at least in part, on the signals received from each of the one or more magnetic proximity sensors.

### DESCRIPTION OF THE DRAWINGS

FIG. 1 is a perspective view of an exemplary brewer made in accordance with the present invention;

FIG. 2 is an alternate perspective view of the exemplary brewer of FIG. 1, in which the brew basket has been installed in another orientation;

FIG. 3 is an alternate perspective view of the exemplary brewer of FIG. 1, in which the brew basket has been installed in yet another orientation;

FIG. 4 is a perspective view of the brew basket of the exemplary brewer of FIG. 1;

FIG. 5 is a side sectional view of the brew basket of FIG. 4;

FIG. 6 is a front view of the exemplary brewer of FIG. 1;

FIG. 7 is a partial bottom view of the exemplary brewer of FIG. 1 taken along line 7-7 of FIG. 6; and

FIG. 8 is a schematic diagram illustrating the use of a control logic to receive and act on signals from one or more magnetic proximity sensors in the exemplary brewer of FIG. 1.

### DETAILED DESCRIPTION OF THE INVENTION

The present invention is a beverage brewer with a control logic that is responsive to the installation and positioning of the brew basket.

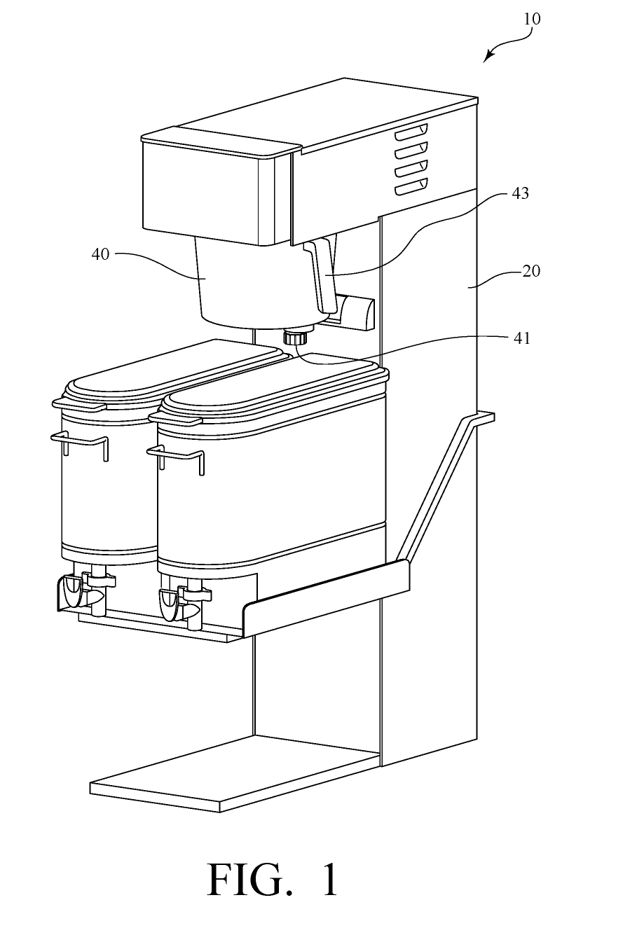

Referring first to FIGS. 1-3, an exemplary brewer 10 made in accordance with the present invention includes a housing 20, along with a brew basket 40 that is selectively installed and secured to the housing 20 and holds a quantity of tea, ground coffee, or similar beverage component below a spray head 30 installed in the housing 20. As with prior art brewer constructions, the brewer 10 also includes a plumbing system in which water is drawn from a water reservoir (or from another source of water). As water is drawn from the reservoir and into a hot water tank, hot water is forced from the hot water tank to the spray head 30. The spray head 30 distributes the hot water over and through the quantity of tea, ground coffee, or similar beverage component held in the brew basket 40, and the brewed beverage is dispensed through an outlet orifice (or drain hole) 41 into a cup or similar receptacle.

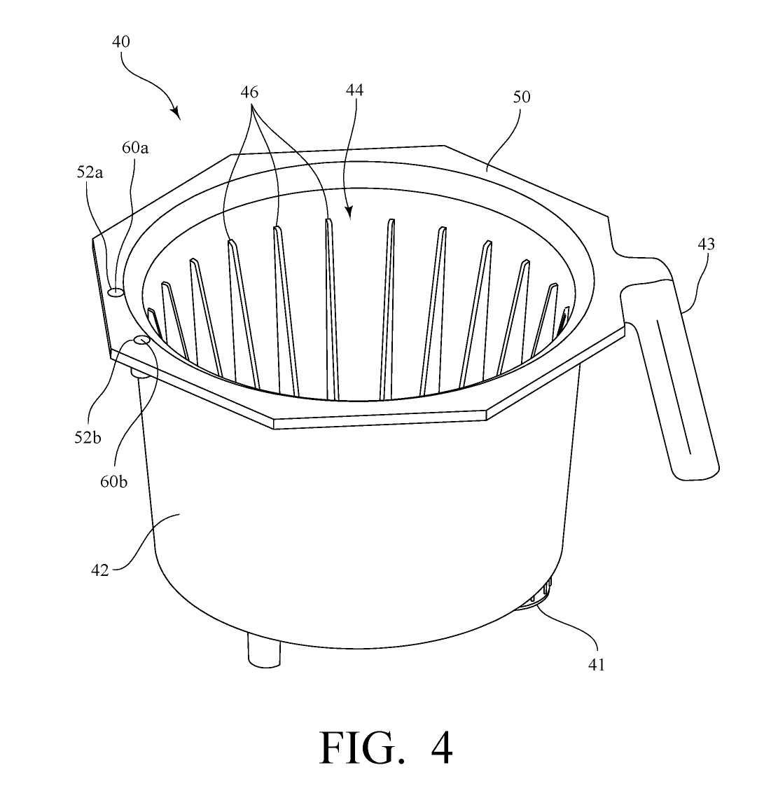

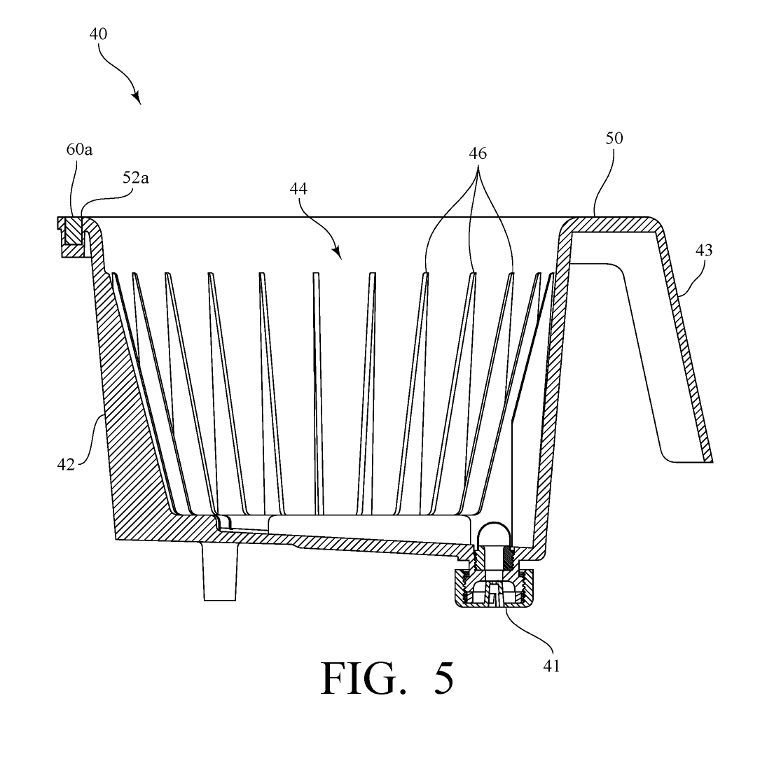

Referring now to FIGS. 4 and 5, in this exemplary embodiment, the brew basket 40 has a generally cylindrical body 42 defining an internal cavity 44 and an open top, which is circumscribed by an upper flange 50. Furthermore, the upper flange 50 has a hexagonal shape, the importance of which will be further discussed below. The brew basket 40 also includes a handle 43. Additionally, ribs 46 extend from the inner wall surface around the circumference of the cylindrical body 42 within the internal cavity 44 of the brew basket 40, such that the ribs 46 are configured to receive and support a filter, pod, or other media, which, in turn, supports or encloses the tea, ground coffee, or similar beverage component.

Referring still to FIGS. 4 and 5, one or more magnets 60a, 60b are installed on the upper flange 50 of the brew basket 40, such that the one or more magnets 60a, 60b will be positioned near the housing 20 of the brewer 10 when the brew basket 40 is installed. Specifically, in this exemplary embodiment, the brew basket 40 includes two integral recesses 52a, 52b on the upper flange 50, each for receiving a magnet 60a, 60b. Although both magnets 60a, 60b are shown in FIG. 4, it is contemplated, for example, that a brew basket 40 for brewing tea may be provided only with a magnet 60a in the first recess 52a at the rear, center portion of the brew basket 40 (i.e., directly opposite the handle 43), whereas a brew basket 40 for brewing coffee may be provided only with a magnet 60b in the second recess 52b, which is offset from the rear, center portion of the brew basket 40. Various other combinations of magnets may also be provided on the upper flange 50 of the brew basket 40 and used to identify the brew basket 40 and/or a desired brewing routine, as further described below.

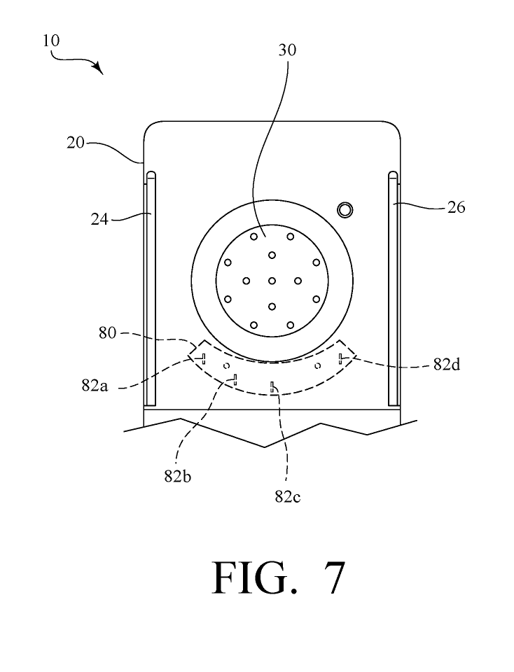

Referring now to FIG. 7, one or more magnetic proximity sensors are installed within the housing 20 of the brewer 10 near the spray head 30. Specifically, in this exemplary embodiment, a circuit board 80 that includes four magnetic proximity sensors 82a, 82b, 82c, 82d is installed in the housing 20 of the brewer 10 adjacent the spray head 30, and such magnetic proximity sensors 82a, 82b, 82c, 82d are positioned to sense the presence of one or more of the magnets 60a, 60b installed on the upper flange 50 of the brew basket 40, i.e., to sense the presence and/or orientation of the brew basket 40.

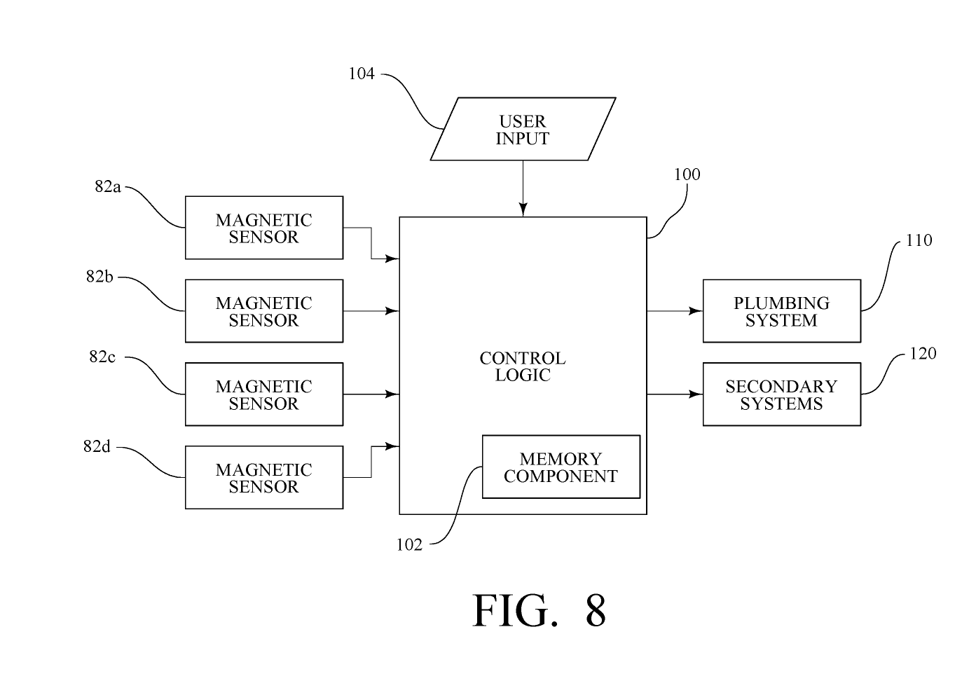

Referring now to the schematic diagram of FIG. 8, a control logic 100 receives signals from each of the magnetic proximity sensors 82a, 82b, 82c, 82d. Based on such signals, the control logic 100 can confirm the presence and/or orientation of the brew basket 40, and thus can determine, for example, whether tea or coffee is to be brewed, or whether a particular brewing routine is desired. When a brewing cycle is then initiated by a start button or similar user input 104, the control logic 100 retrieves a brewing routine, which is a set of computer-readable instructions, from a memory component 102. The control logic 100 executes those instructions and communicates appropriate control signals to the plumbing system 110 based, at least in part, on the signals received from each of the one or more magnetic proximity sensors 82a, 82b, 82c, 82d. For example, the control logic 100 can send an appropriate control signal to open a fill valve of the plumbing system 110 for a predetermined period of time to determine how much hot water is delivered to the spray head 30 and at what rate. The brewing routines (or instructions) can be coded into a computer-readable form using standard programming techniques and languages, and such programming is readily accomplished by one of ordinary skill in the art. For example, in this exemplary embodiment, if the magnetic proximity sensor 82b senses the presence of a magnet at its location, the control logic 100 identifies this as an indication that coffee is to be brewed, and the control logic 100 thus retrieves and executes the appropriate brewing routine to brew coffee.

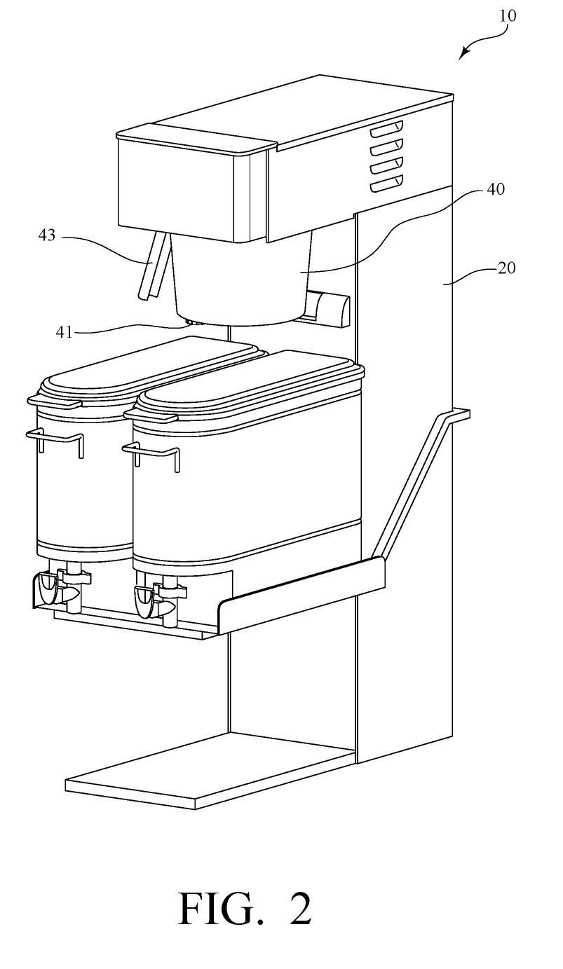

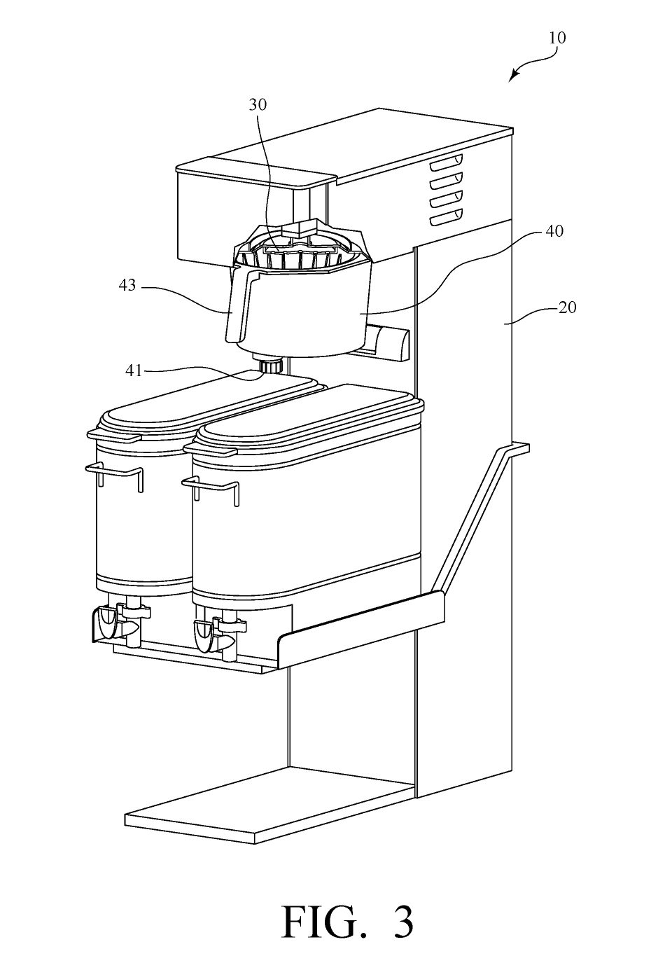

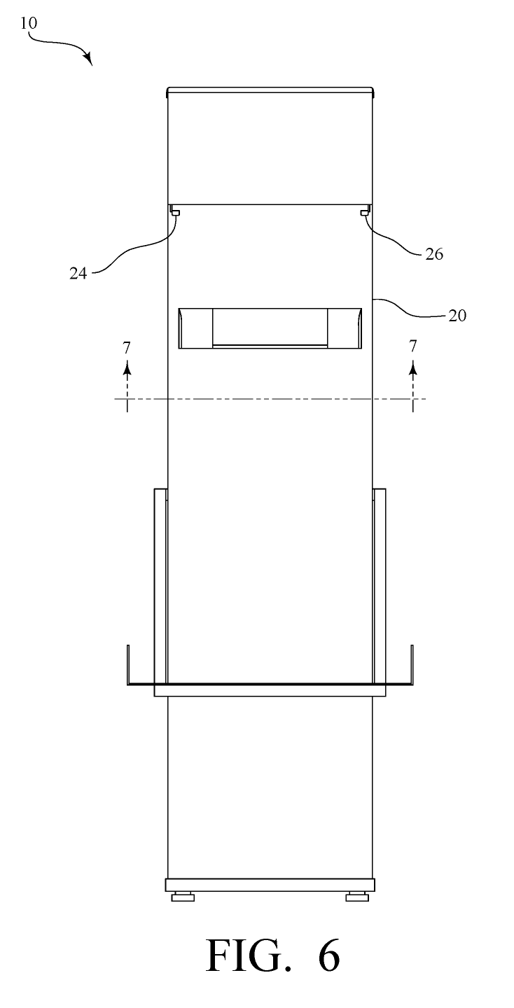

For another example, in this exemplary embodiment, if any one of the magnetic proximity sensors 82a, 82c, 82d senses the presence of a magnet at its location, the control logic 100 identifies this as an indication that tea is to be brewed. Furthermore, depending on which magnetic proximity sensor 82a, 82c, 82d senses the presence of a magnet at its location, the control logic 100 may further recognize that a particular brewing routine for tea is to be executed. The control logic 100 then retrieves and executes the appropriate brewing routine to brew tea. In this regard, because of the hexagonal shape of the upper flange 50 of the brew basket 40 (see FIG. 4), which engages brackets 24, 26 on the underside of the housing 20 near the brew head 30 (see FIGS. 6-7), the brew basket 40 can be installed in at least three different orientations or positions, i.e., with the handle 43 straight out (FIG. 3), with the handle 43 left (FIG. 2), or with the handle 43 right (FIG. 1).

Furthermore, rotating the brew basket 40 in this manner may also determine which of two side-by-side urns are filled, i.e., a left urn or a right urn, as shown in FIGS. 1 and 2.

With respect to the various possible routines for brewing tea, in some cases, cold water and/or sweeteners may be introduced into the brewed beverage. Thus, the selected position of the brew basket 40 may serve as a selection of such a routine that introduces cold water and/or sweeteners into the brewed beverage. In other words, as also shown in FIG. 8, the control logic 100 may communicate instructions to secondary systems 120 that are separate and apart from the plumbing system 110, for example, a delivery system for cold water and/or sweeteners.

Additionally, if the brew basket 40 is removed during a brewing routine, and none of the magnetic proximity sensors 82a, 82b, 82c, 82d senses the presence of a magnet at its location, the control logic 100 can then terminate the brewing routine.

One of ordinary skill in the art will recognize that additional embodiments are possible without departing from the teachings of the present invention. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. A beverage brewer, comprising:
a housing;
a spray head mounted to the housing and operably connected to a source of water;
a brew basket that is selectively installed and secured to the housing, said brew basket holding a quantity of a beverage component below the spray head, such that, in use, water introduced by the spray head contacts and passes through the beverage component to produce a brewed beverage;
one or more magnets installed on the brew basket;
one or more magnetic proximity sensors installed in the housing and positioned to sense the presence of the one or more magnets installed on the brew basket; and
a control logic configured to receive signals from the one or more magnetic proximity sensors, said control logic executing a selected brewing routine in response to the signals received from the one or more magnetic proximity sensors.

2. The beverage brewer as recited in claim 1, wherein the brew basket includes an upper flange, and the one or more magnets are installed on the upper flange of the brew basket.

3. The beverage brewer as recited in claim 2, wherein the upper flange of the brew basket has a predetermined shape, such that the brew basket be rotated and installed in multiple orientations relative to the housing and below the spray head.

4. The beverage brewer as recited in claim 3, wherein the upper flange of the brew basket has a hexagonal shape.

5. The beverage brewer as recited in claim 4, wherein the brew basket be rotated and installed in three positions relative to the housing and below the spray head. A beverage brewer, comprising:
a housing;
a spray head mounted to the housing and operably connected to a source of water;
a brew basket for holding a quantity of a beverage component below the spray head, such that, in use, water introduced by the spray head contacts and passes through the beverage component to produce a brewed beverage;
one or more sensors installed in the housing and positioned to sense the presence and orientation of the brew basket; and
a control logic configured to receive signals from the one or more sensors, said control logic executing a selected brewing routine in response to the signals received from the one or more sensors.

7. The beverage brewer as recited in claim 6, wherein the one or more sensors are proximity sensors.
